(19) United States
(12) Patent Application Publication
(10) Pub. No.: US 2025/0301054 A1
(43) Pub. Date: Sep. 25, 2025

(54) RELAY DEVICE, DATA RELAY METHOD, AND PROGRAM

(71) Applicant: DENSO CORPORATION, Kariya-city (JP)

(72) Inventor: Taichi ITAGAWA, Kariya-city (JP)

(21) Appl. No.: 19/045,712

(22) Filed: Feb. 5, 2025

(30) Foreign Application Priority Data
Mar. 21, 2024 (JP) 2024-045094

(51) Int. Cl. H04L 69/08; H04L 45/745; H04L 61/09

(52) U.S. Cl. CPC H04L 69/08; H04L 45/745; H04L 61/09

(57) ABSTRACT

A relay device, a data relay method, or a non-transitory computer-readable storage medium storing a program relays data between a plurality of electronic devices, performs mutual conversion between a first protocol used for communication with a first electronic device and a second protocol used for communication with a second electronic device, and converts an external address, and convert an internal address according to a conversion table. A plurality of external addresses are assigned to one first electronic device. The conversion table is set to associate a different external address with each type of a second protocol identified by speed-related information.

### CROSS REFERENCE TO RELATED APPLICATION

The present application claims the benefit of priority from Japanese Patent Application No. 2024-045094 filed on Mar. 21, 2024. The entire disclosure of the above application is incorporated herein by reference.

### TECHNICAL FIELD

The present disclosure relates to a technology for relaying between networks with different protocols.

### BACKGROUND

In a comparative example, an in-vehicle system uses multiple types of protocols with different communication speeds for communication between a relay device and an ECU.

### SUMMARY

A relay device, a data relay method, or a non-transitory computer-readable storage medium storing a program relays data between a plurality of electronic devices, performs mutual conversion between a first protocol used for communication with a first electronic device and a second protocol used for communication with a second electronic device, and converts an external address, and convert an internal address according to a conversion table. A plurality of external addresses are assigned to one first electronic device. The conversion table is set to associate a different external address with each type of a second protocol identified by speed-related information.

### BRIEF DESCRIPTION OF THE DRAWINGS

The above and other features and advantages of the present disclosure will become more apparent from the following detailed description made with reference to the accompanying drawings, in which like parts are designated by like reference numbers.

FIG. 1 is a block diagram showing a configuration of an in-vehicle system.

FIG. 2 is an explanatory diagram illustrating a combination of protocols.

FIG. 3 is an explanatory diagram illustrating contents of a conversion table.

FIG. 4 is a sequence diagram showing an operation performed when a diagnostic message is transmitted from an external tool to an ECU.

FIG. 5 is a sequence diagram showing an operation when a diagnostic message is transmitted from an ECU to an external tool.

FIG. 6 is an explanatory diagram showing the effect of performing communication with an external tool via multiple connections.

FIG. 7 is a sequence diagram showing an operation when updating a conversion table in a second embodiment.

FIG. 8 is an explanatory diagram illustrating an example of a combination of protocols associated with a connection.

### DETAILED DESCRIPTION

In an in-vehicle system, Ethernet is used to connect an external tool to a relay device, and Ethernet and CAN may be used together to connect multiple ECUs to be diagnosed to the relay device. The Ethernet and CAN are registered trademarks. An example of diagnostic communication in Ethernet is DoIP, and an example of diagnostic communication in CAN is DoCAN. Even when data has a length that can be transmitted in one frame in DoIP, it must be divided into multiple frames for transmission in DoCAN.

Incidentally, the DoIP standard limits the number of TCP connections to one per logical address used to identify a device. In other words, in a TCP connection associated with an external tool, when an ECU starts a series of data transfers, the ECU cannot start data transfers for other ECUs until the series of data transfers is completed.

Therefore, when relaying is started by an ECU connected to a relay device via CAN, there is a difficulty that the waiting time becomes long until relaying is started by an ECU connected to the relay device via the faster Ethernet.

One example of the present disclosure provides a technology for improving communication efficiency in diagnostic communication in which multiple types of protocols with different communication speeds are mixed.

According to one example embodiment of the present disclosure, a relay device relays data between multiple electronic devices, and comprises a protocol conversion unit and an address conversion unit. The protocol conversion unit is configured to perform conversion between a first protocol used for communication with a first electronic device and a second protocol used for communication with a second electronic device. The address conversion unit is configured to convert an external address indicated in a message from the first electronic device to the second electronic device into an internal address, and to convert the internal address indicated in a message from the second electronic device to the first electronic device into the external address, according to a conversion table. The conversion table mutually associates the external address and the internal address, which are address information used to indicate the first electronic device in a higher protocol. One first electronic device is assigned multiple external addresses. The conversion table is set so that a different external address is associated with each type of second protocol identified by the speed-related information. The speed-related information is information used when identifying the type of the second protocol based on differences in communication speed.

According to this configuration, it is possible to improve communication efficiency in diagnostic communication in which multiple types of protocols with different communication speeds are mixed. One aspect of the present disclosure is a data relay method for relaying data between multiple electronic devices. The data relay method includes performing mutual conversion between a first protocol used for communication with a first electronic device and a second protocol used for communication with a second electronic device. The data relay method includes converting an external address indicated in a message from the first electronic device to the second electronic device into an internal address, and to convert an internal address indicated in a message from the second electronic device to the first electronic device into an external address, according to a conversion table. The conversion table associates the external address and the internal address, which are address information used to indicate the first electronic device in a higher protocol. One first electronic device is assigned multiple external addresses. The conversion table is set so that a different external address is associated with each type of second protocol identified by the speed-related information. The speed-related information is information used when identifying the type of the second protocol based on differences in communication speed. By executing such a method, it is possible to obtain the same effect as the relay device described above.

Another example of the present disclosure is a program for causing a computer to function as the relay device described above. By executing such a program, it is possible to obtain the same effect as the relay device described above.

Hereinafter, embodiments of the present disclosure will be described with reference to drawings.

### 1. FIRST EMBODIMENT

### 1-1. Configuration

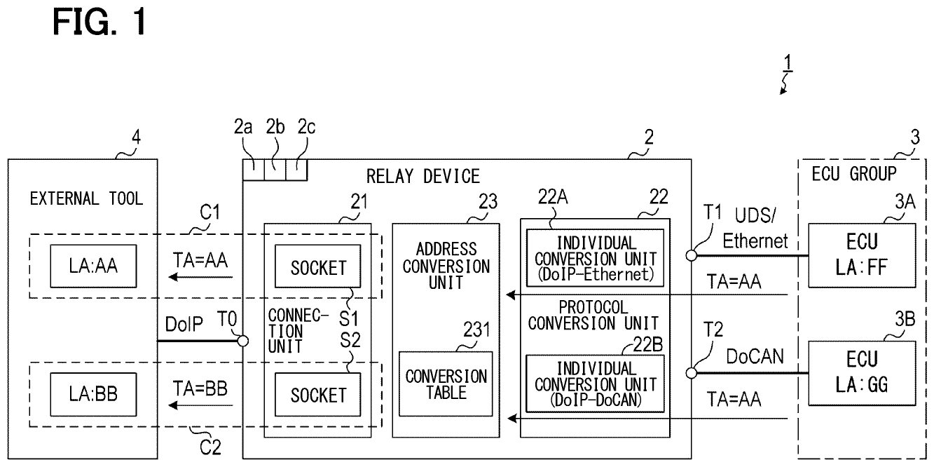

As shown in FIG. 1, an in-vehicle system 1 of the present embodiment is mounted on a vehicle. The vehicle may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the traveling source. Hereinafter, the vehicle equipped with the in-vehicle system 1 will be simply referred to as a vehicle.

The in-vehicle system 1 includes a relay device 2 and a group of electronic control units (hereinafter, referred to as ECUs) 3. The ECU is an abbreviation for Electronic Control Unit. The relay device 2 includes one or more external connection terminals T0 and multiple internal connection terminals T1 and T2. An external tool 4 is connected to the external connection terminal T0. An ECU 3A belonging to the ECU group 3 is connected to the internal connection terminal T1 via a first internal network. An ECU 3B belonging to the ECU group 3 is connected to the internal connection terminal T2 via a second internal network that uses a protocol for communication different from that of the first internal network. The relay device 2 may include multiple internal connection terminals T1 and multiple internal connection terminals T2. In addition to the internal connection terminals T1, T2, the relay device 2 may also include one or more internal connection terminals that are connected to an ECU via an internal network using a protocol different from that used for communication with the first and second internal networks. The relay device 2 relays data between the external tool 4 connected to the external connection terminal TO and an ECU connected to internal connection terminals T1 and T2.

Hereinafter, the protocol used for diagnostic communication between the relay device 2 and the external tool 4 is referred to as the first higher protocol, and the protocol used for diagnostic communication between the relay device 2 and each ECU belonging to the ECU group 3 is referred to as the second higher protocol. In addition, a protocol lower than the first higher protocol used to connect the relay device 2 and the external tool 4 is defined as the first lower protocol, and a protocol lower than the second higher protocol used to connect the relay device 2 and each ECU belonging to the ECU group 3 is defined as the second lower protocol. The first lower protocol and the first higher protocol are also collectively referred to as a first protocol P1, and the second lower protocol and the second higher protocol are also collectively referred to as a second protocol P2.

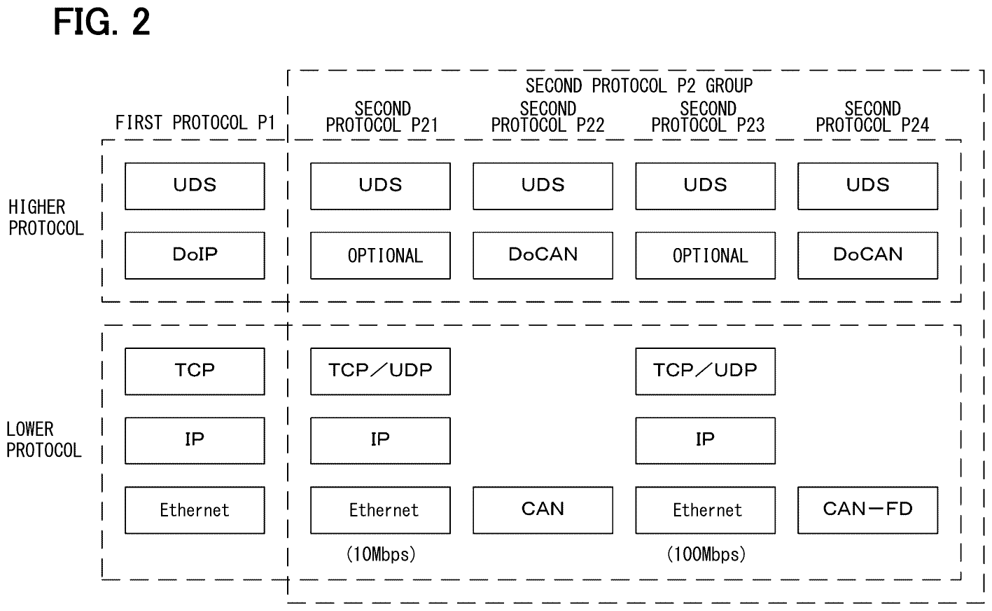

As shown in FIG. 2, in the present embodiment, the first higher protocol is UDS and DoIP, and the first lower protocol is TCP, IP, and Ethernet. The Ethernet is a registered trademark. The UDS is an abbreviation for Unified Diagnostic Services, which is a unified diagnostic service for automobiles standardized by ISO14229. The DoIP is an abbreviation for Diagnostics over Internet Protocol, and is an Ethernet-based diagnostic protocol standardized by ISO13400.

There are multiple types of second protocols P2, which are identified as second protocols P21 to P24 in the present embodiment. The second protocols P21 to P24 are collectively referred to as a second protocol group. In both the second protocol P21 and the second protocol P23, the lower protocols are TCP/UDP, IP, and Ethernet, and the higher protocols are UDS and optional. The expression of “optional” may mean that any protocol can be used as the protocol connecting the UDS and the lower protocol. The second protocol P21 and the second protocol P23 differ in the physical layer of the Ethernet. Specifically, the second protocol P21 uses an Ethernet compatible with a communication speed of 10 Mbps, and the second protocol P23 uses an Ethernet compatible with a communication speed of 100 Mbps. In other words, the type of the second protocol may be distinguished including the physical layer.

The second protocol P22 has the higher protocols of UDS and DoCAN, and the lower protocol of CAN. The second protocol P24 has higher protocols of UDS and DoCAN, and a lower protocol of CAN FD. The CAN is a registered trademark and is an abbreviation for Controller Area Network. The CAN FD is an abbreviation for CAN with Flexible Data Rate. The DoCAN is an abbreviation for Diagnostic communication over Controller Area Network, and is a CAN-based diagnostic protocol standardized by ISO15765.

The second protocols P21 to P24 belonging to the second protocol group differ from each other in at least one of the communication speed and the data length that can be transmitted in one frame. As shown in FIG. 1, the relay device 2 is an electronic control unit mainly including a microcomputer including a CPU 2a, a ROM 2b, a RAM 2c, and the like. Various functions of the microcomputer are implemented by the CPU 2a executing programs stored in a non-transitory tangible storage medium. In this example, the ROM 2b corresponds to a non-transitory tangible storage medium that stores a program. Further, by executing this program, a method corresponding to the program is executed. Note that partial or all of the functions executed by the CPU 2a may be implemented by a hardware circuit, such as one or more ICs. Further, the number of the microcomputers constituting the relay device 2 may be one or more.

### 1-2. Functional Configuration of Relay Device

The functional configuration of the relay device 2 will be described. For ease of explanation, FIG. 1 shows a case in which there are one internal connection terminal T1 and one internal connection terminal T2.

The ECUs 3A, 3B and the external tool 4 are assigned a logical addresses LA for identifying devices that are targets of diagnostic communication in a higher protocol. Specifically, an address of LA=FF is assigned to the ECU 3A, and an address of LA=GG is assigned to the ECU 3B. In addition, the external tool 4 is assigned the same number of logical addresses as the types of second protocols used by the relay device 2 to communicate with each ECU 3A, 3B belonging to the ECU group 3, i.e., two logical addresses of LA=AA and LA=BB.

The relay device 2 includes a connection unit 21, a protocol conversion unit 22, and an address conversion unit 23 as functional blocks that are implemented by the CPU 2a or the like executing a program stored in the ROM 2b or the like.

The connection unit 21 has sockets S1, S2 in the same number as the types of second protocols used by the relay device 2 for communication with each ECU belonging to the ECU group 3 (i.e., two). The sockets S1 and S2 provide connections C1 and C2 of a lower protocol used for communication with the external tool 4 connected to the external connection terminal TO. The sockets S1 and S2 are associated with an IP address indicating the same external tool 4 and different TCP port numbers. It has a function of distributing data provided from higher layer programs that use the sockets S1 and S2 to appropriate applications at appropriate communication destinations. When there are multiple external connection terminals T0, the connection unit 21 is provided for each external connection terminal.

The protocol conversion unit 22 includes individual conversion units 22A and 22B prepared for each type of second protocol. The individual conversion unit 22A performs protocol conversion of a diagnostic communication message transmitted and received via the internal connection terminal T1 connected to an internal network communicating with the ECU 3A using the second protocol P21. Specifically, the individual conversion unit 22A executes protocol conversion between the first protocol P1 and the second protocol P21.

The individual conversion unit 22B executes protocol conversion of a diagnostic communication message transmitted and received via the internal connection terminal T2 connected to an internal network communicating with the ECU 3B using the second protocol P22. Specifically, the individual conversion unit 22B executes protocol conversion between the first protocol P1 and the second protocol P22. The individual conversion unit 22B has a function of generating multiple DoCAN messages conforming to the second protocol P22 from one DoIP message conforming to the first protocol P1. The individual conversion unit 22B also has a function of generating one DoIP message conforming to the first protocol P1 from multiple DoCAN messages conforming to the second protocol P22.

The address conversion unit 23 includes a conversion table 231. The address conversion unit 23 converts the value of the logical address LA of the external tool 4 indicated as the transmission destination or transmission source in the header information of the higher layer protocol in accordance with the conversion table 231.

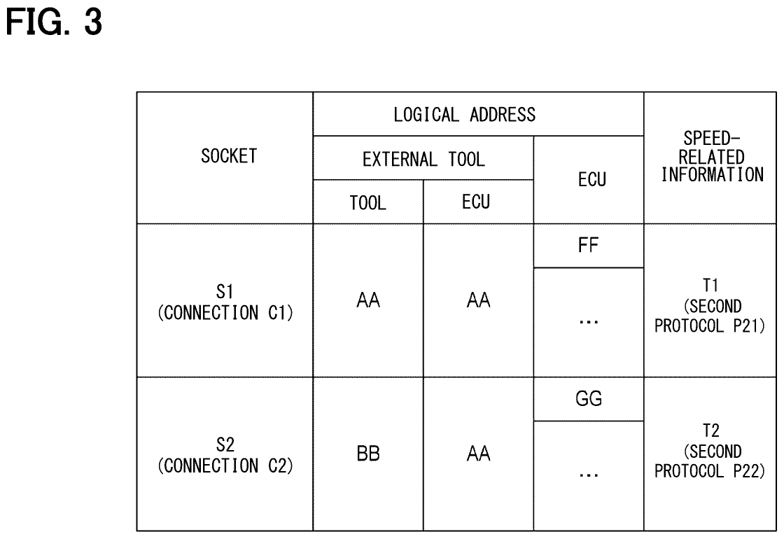

As shown in FIG. 3, for each socket S1, S2 of the connection unit 21, the conversion table 231 associates a logical address LA indicating the external tool 4, a logical address LA indicating the ECU with which the external tool 4 communicates, and speed-related information. The speed-related information is information used to identify the type of the second protocol P2.

The logical address indicating the external tool 4 includes a tool address (also referred to as a pair tool address) used in communication between the external tool 4 and the relay device 2, and an ECU address (also referred to as a pair ECU address) used in communication between the ECUs 3A, 3B and the relay device 2. The logical addresses indicating the ECUs list the logical addresses of all the ECUs that communicate with the relay device 2 using the same type of second protocol P2.

The speed-related information is information used to identify the type of the second protocol P2 with a focus on the communication speed. In this case, information for identifying the internal connection terminals T1, T2 is used. In other words, a different second protocol P2 is used for the internal connection terminal T1 and the internal connection terminal T2. Therefore, when it is determined whether the communication was received at the internal connection terminal T1 or T2, it is possible to identify the type of second protocol P2 used for the communication, and further identify the communication speed.

The conversion table 231 shown in FIG. 3 indicates that of the two logical addresses LA assigned to the external tool 4, the address of LA=AA is associated with the socket S1, and the address of LA=BB is associated with the socket S2. The conversion table 231 indicates that the socket S1 is used when transmitting and receiving diagnostic messages between the external tool 4 and the relay device 2, the diagnostic messages being transmitted and received by the ECU 3A. The ECU 3A is connected to the internal connection terminal T1 and uses the second protocol P21 for communication with the relay device 2. In addition, the conversion table 231 indicates that the socket S2 is used when transmitting and receiving diagnostic messages between the external tool 4 and the relay device 2, the diagnostic messages being transmitted and received by the ECU 3B. The ECU 3B is connected to the internal connection terminal T2 and uses the second protocol P22 for communication with the relay device 2.

The ECU addresses of the sockets S1 and S2 are both set to the same value. Here, the LA=AA, which is one of the logical addresses assigned to the external tool 4, is used. Hereinafter, the connection established between the external tool 4 and the relay device 2 via the socket S1 is denoted by C1, and the connection established between the external tool 4 and the relay device 2 via the socket S2 is denoted by C2. That is, the conversion table 231 shown in FIG. 3 is set so that the connection C1 is used for communication with the ECU 3A using the second protocol P21, and the connection C2 is used for communication with the ECU 3B using the second protocol P22.

### 1-3. Operation

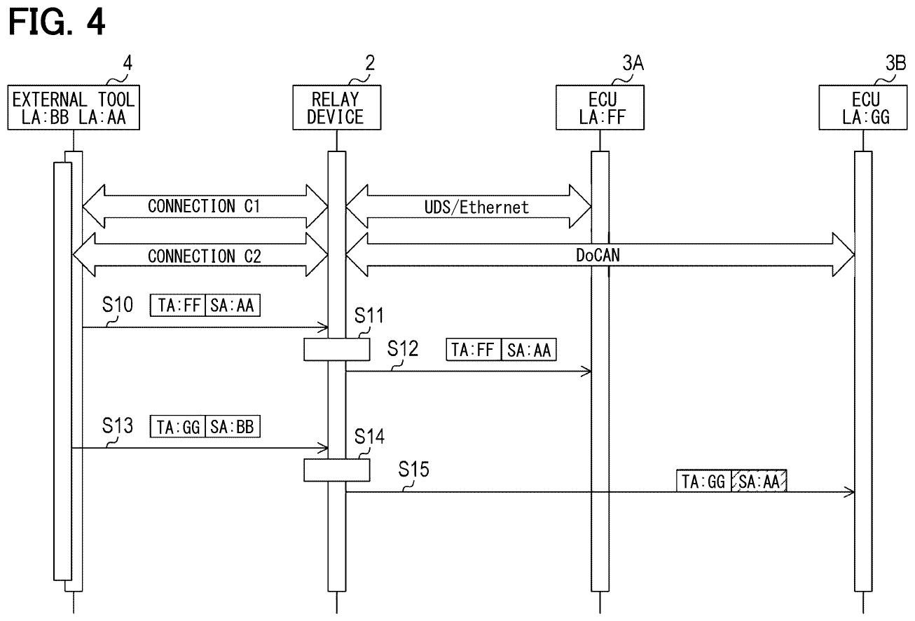

The operation of the external tool 4 when transmitting the diagnostic message to the ECU 3A using the second protocol P21 and the ECU 3B using the second protocol P22 will be described with reference to the sequence diagram of FIG. 4.

The external tool 4 and the relay device 2 are connected by two connections C1, C2 using two sockets S1, S2, and are set so that communication using the first protocol P1 is possible on each connection. Of the two logical addresses LA possessed by the external tool 4, the address of LA=AA is associated with the connection C1, and the address of LA=BB is associated with the connection C2. In addition, the relay device 2 and the ECU 3A are configured to communicate with each other using the second protocol P21, and the relay device 2 and the ECU 3B are configured to communicate with each other using the second protocol P22. Hereinafter, a logical address representing a transmission destination device used in a higher protocol when transmitting and receiving the diagnostic message is indicated as TA, and a logical address representing a transmission source device is indicated as SA.

As shown in FIG. 4, in S10, when the external tool 4 transmits the diagnostic message to the ECU 3A, the external tool 4 transmits the diagnostic message with the setting of TA=FF and SA=AA to the relay device 2 via the connection C1 associated with the logical address of LA=AA.

In S11, the relay device 2 converts the SA indicated in the diagnostic message received from the external tool 4 according to the conversion table 231. Specifically, since the relay device 2 receives the diagnostic message via the connection C1, it converts SA from the tool address AA to the ECU address AA. That is, in this case, the value of SA is the same before and after the conversion.

In S12, the relay device 2 transmits the address-converted diagnostic message to the ECU 3A identified by the TA of the diagnostic message by outputting the address-converted diagnostic message via the internal connection terminal T1 indicated in the speed-related information.

In S13, when the external tool 4 transmits the diagnostic message to the ECU 3B, the external tool 4 transmits the diagnostic message with TA=GG and SA=BB set to the relay device 2 via the connection C2 associated with the logical address LA=BB.

In S14, the relay device 2 converts the SA indicated in the diagnostic message received from the external tool 4 according to the conversion table 231. Specifically, since the relay device 2 receives the diagnostic message via the connection C2, it converts SA from the tool address BB to the ECU address AA. That is, in this case, the value of SA will be different before and after the conversion.

In S15, the relay device 2 transmits the address-converted diagnostic message to the ECU 3B identified by the TA of the diagnostic message by outputting the address-converted diagnostic message via the internal connection terminal T2 indicated in the speed-related information.

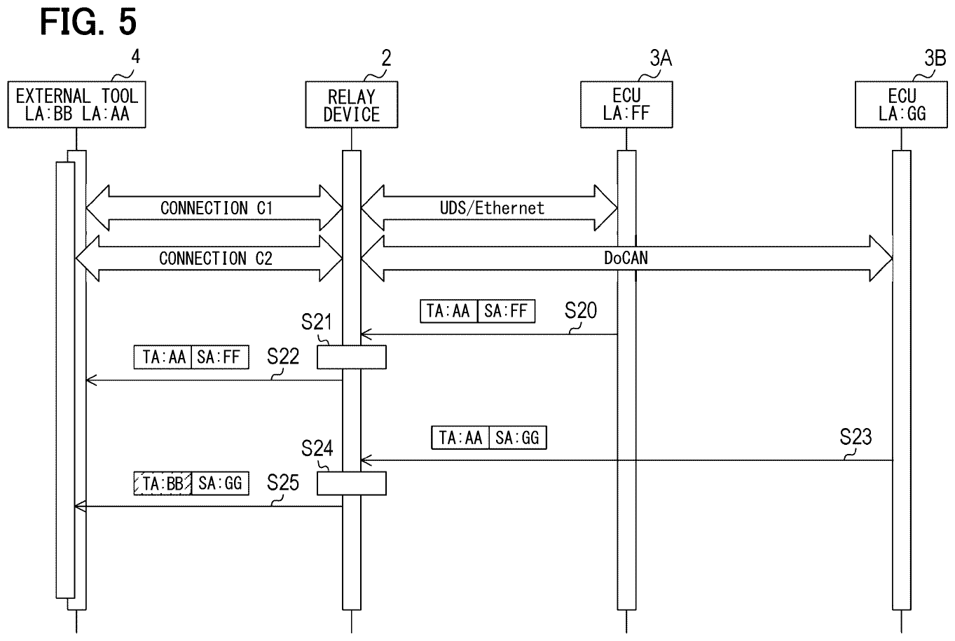

Next, the operation in a case where the ECU 3A using the second protocol P21 and the ECU 3B using the second protocol P22 transmit the diagnostic message to the external tool 4 will be described with reference to the sequence diagram of FIG. 5.

In S20, when the ECU 3A transmits the diagnostic message to the external tool 4, the ECU 3A transmits the diagnostic message with the setting of TA=AA and SA=FF to the relay device 2. In S21, the relay device 2 converts the TA indicated in the diagnostic message received from the ECU 3A in accordance with the conversion table 231. Specifically, in order to receive the diagnostic message via the internal connection terminal T1, the relay device 2 converts TA from the ECU address AA to the tool address AA. That is, in this case, the value of TA is the same before and after the conversion.

In S22, the relay device 2 transmits the address-converted diagnostic message to the external tool 4 via the connection C1 associated with the internal connection terminal T1 as the speed-related information in the conversion table 231.

In S23, when the ECU 3B transmits the diagnostic message to the external tool 4, the ECU 3B transmits the diagnostic message with the setting of TA=AA and SA=GG to the relay device 2. In S24, the relay device 2 converts the TA indicated in the diagnostic message received from the ECU 3B in accordance with the conversion table 231. Specifically, in order to receive the diagnostic message via the internal connection terminal T2, the relay device 2 converts TA from the ECU address AA to the tool address BB. That is, in this case, the value of TA is different before and after the conversion.

In S25, the relay device 2 transmits the address-converted diagnostic message to the external tool 4 via the connection C2 associated with the internal connection terminal T2 as the speed-related information in the conversion table 231.

### 1-4. Correspondence of Terms

In the present embodiment, the external tool 4 corresponds to a first electronic device of the present disclosure, and each of the ECUs 3A and 3B belonging to the ECU group 3 corresponds to a second electronic device of the present disclosure. In the present embodiment, the tool address corresponds to an external address of the present disclosure, and the ECU address corresponds to an internal address of the present disclosure. In the present embodiment, the internal connection terminals T1 and T2 correspond to information for identifying a physical path of the present disclosure, and the logical address LA corresponds to address information of the present disclosure. The connections C1 and C2 in the present embodiment correspond to connections in the present disclosure.

### 1-5. Effects

According to a first embodiment described in detail above, the following effects are achieved.

(1a) The relay device 2 is used for communication with the ECUs 3A and 3B, and uses multiple sockets S1, S2 for communication with the external tool 4 depending on the type of the second protocol P2, which is classified based on the communication speed. Therefore, according to the relay device 2, communication between the external tool 4 and the relay device 2 can prevent the delay in the communication with the ECU 3A using the second protocol P21 with the faster communication speed due to the communication with the ECU 3B using the second protocol P22 with the slower communication speed.

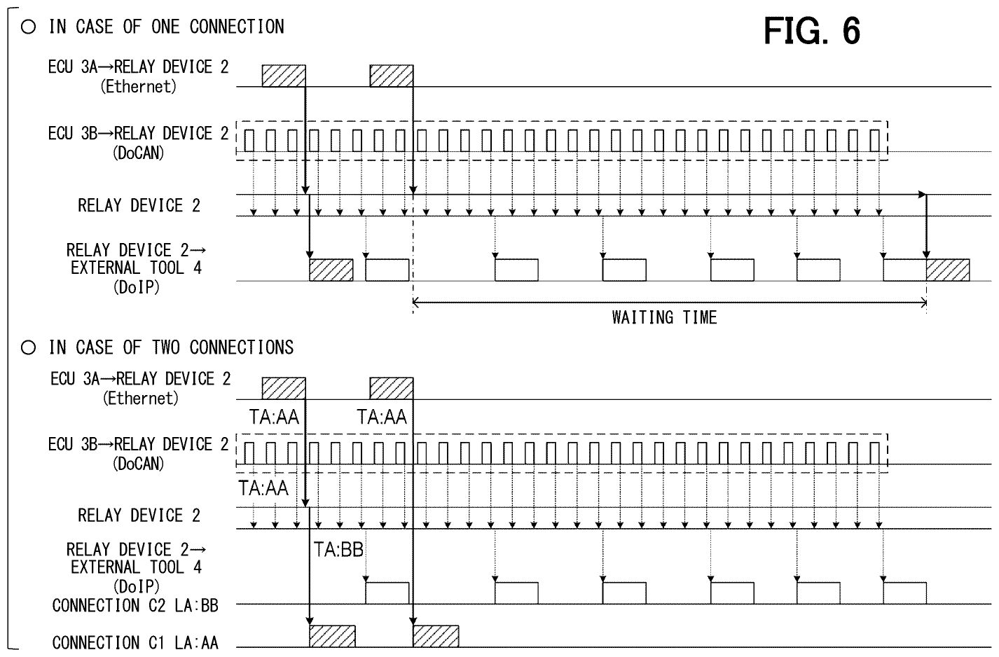

The reasons why the communication delay is prevented are as follows. As shown in FIG. 6, it is assumed that the ECU 3A using the second protocol P21 (i.e., Ethernet) and the ECU 3B using the second protocol P22 (i.e., DoCAN) start communication with the external tool 4 almost simultaneously. Also, the diagnostic message from the ECU 3A is completed in one frame, whereas the diagnostic message from the ECU 3B requires several tens of frames.

In FIG. 6, the upper part shows a case where one connection can be used for communication between the external tool 4 and the relay device 2, and the lower part shows a case where two connections can be used. The relay device 2 transfers the reception frames from the ECU 3A to the external tool 4 on a frame-by-frame basis, and transfers the diagnostic message (i.e., DoCAN message) from the ECU 3B to the external tool 4 by consolidating multiple frames of data into a single diagnostic message (i.e., DoIP message).

Reception from ECU 3B starts first, but reception of the diagnostic message, which is completed in one frame, from ECU 3A is completed before reception of multiple DoCAN messages (for example, six) required to transmit the first DoIP message is completed. At this time, since the connection with the external tool 4 is unused, the DoIP message based on the diagnostic message from the ECU 3A is transmitted to the external tool 4 regardless of whether there is one connection or two connections.

After that, a first DoIP message based on the series of DoCAN messages from the ECU 3B is transmitted to the external tool 4. Then, in the case where there is one connection, the connection between the relay device 2 and the external tool 4 is occupied for the ECU 3B until all DoIP messages based on the series of DoCAN frames transmitted from the ECU 3B are received by the external tool 4. Therefore, while the connection is occupied by the ECU 3B, the diagnostic message received from ECU 3A cannot be immediately transmitted to the external tool 4, and is in a state of waiting for transmission until the occupation of the connection by the ECU 3B is released.

On the other hand, the relay device 2 that transmits and receives the DoIP messages to and from the external tool 4 using different connections C1 and C2 for each type of the second protocol P2 is as follows. In other words, even when transmission of the DoIP message based on a series of DoCAN messages received from ECU 3B is ongoing, the DoIP message based on a diagnostic message received from ECU 3A can be transmitted to the external tool 4 using a connection C2 other than the connection C1 being used by ECU 3B. In other words, transmission can be performed from the ECU 3A using the second protocol P21 with the faster communication speed to the external tool 4 without waiting for completion of transmission from the ECU 3B to the external tool 4 using the second protocol P22, which has a slower communication speed.

(1b) In the relay device 2, the logical address LA indicating the external tool 4 is different between the tool address and the ECU address, and the ECU address is set in common to all the ECUs 3A, 3B. Therefore, the ECUs 3A and 3B can communicate with the external tool 4 using a common ECU address without being aware of the use of multiple logical addresses LA (i.e., tool addresses) assigned to the external tool 4.

### 2. SECOND EMBODIMENT

### 2-1. Difference from First Embodiment

The fundamental configuration of a second embodiment is similar to that of the first embodiment. Therefore, the difference therebetween will be described below. The same reference numerals as in the first embodiment denote the same elements, and reference is made to the preceding description.

In the above-described first embodiment, the preset conversion table 231 is used. In contrast, the second embodiment differs from the first embodiment in that the conversion table 231 is rewritable.

### 2-2. Operation

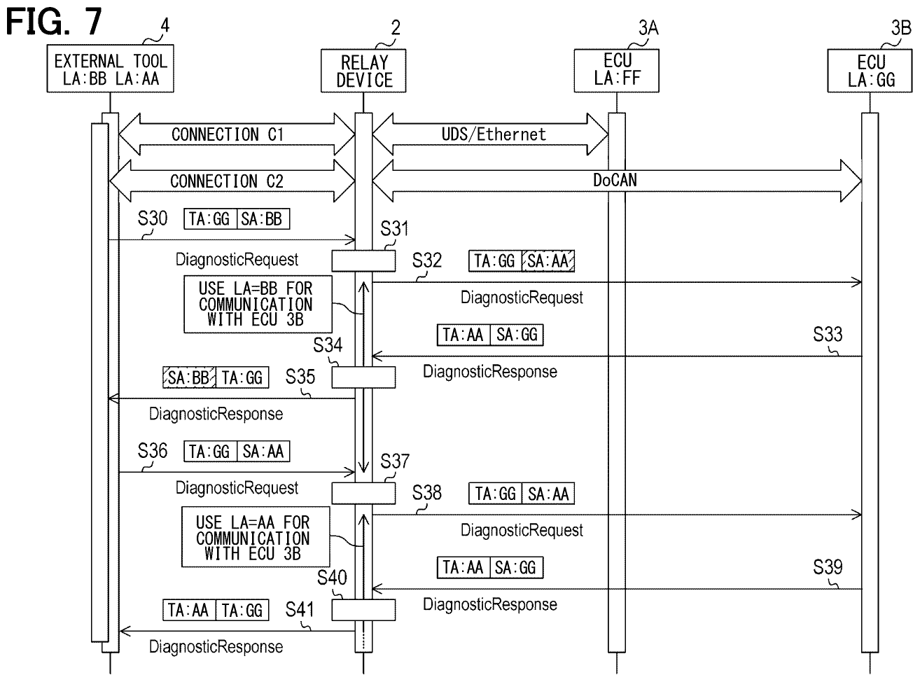

The operation when the conversion table 231 is rewritable will be described with reference to the sequence diagram of FIG. 7.

The initial state of the conversion table 231 is that all items other than the tool address indicating the external tool 4 are set, and the rule address may be in an unset state or may have some initial value written therein. That is, the type of the second protocol P2 and the connections C1, C2 are associated in advance in the conversion table 231, and the association with the logical address indicating the external tool 4 can be set arbitrarily.

As shown in FIG. 7, in S30, when the external tool 4 wishes to change the correspondence between the logical addresses of AA, BB assigned to itself and the connections C1, C2, it transmits a request message (Diagnostic Request) to the relay device 2. For example, when it is desired to use logical address of LA=BB for communication with ECU 3B that uses the second protocol P22, a request message with the setting of TA=GG and SA=BB is transmitted to the relay device 2 using the connection C2 associated with the second protocol P22.

In S 31, the relay device 2 updates the contents of the conversion table 231 in accordance with the request message received from the external tool 4. Specifically, the tool address of the external tool 4 associated with the connection C2 that received the request message is rewritten to the value indicated in the SA of the request message (i.e., BB). Thereafter, the logical address BB is used for communication between the external tool 4 and the ECU 3B. Moreover, the content of the process executed after updating the conversion table 231 in S31 is the same as that described in S14.

In S32, the relay device 2 transmits the address-converted request message to the ECU 3B in the same manner as described in S15. In S33, the ECU 3B transmits, to the relay device 2, the response message (Diagnostic Response) with the setting of TA=AA and SA=GG in response to the received request message.

In S34, the relay device 2 converts the TA indicated in the response message in the same manner as described in S24. In S35, the relay device 2 transmits the address-converted response message to the external tool 4 in the same manner as described in S25.

Thereafter, when it is desired to change the logical address LA used for communication with ECU 3B to AA, in S36, the external tool 4 transmits the request message with the settings of TA=GG and SA=AA to the relay device 2 via the connection C2 associated with the second protocol P22.

In S37, the relay device 2 updates the contents of the conversion table 231 in the same manner as described in S31. In this case, the tool address associated with the connection C2 is rewritten to AA, which is the value indicated in the SA of the request message. Hereinafter, the logical address AA is used for communication between the external tool 4 and the ECU 3B. Moreover, the content of the process executed after updating the conversion table 231 in S37 is the same as that described in S14.

Hereinafter, the contents of the processes in S38 to S41 are the same as those in S32 to S35.

### 2-3. Effects

The second embodiment described in detail above provides the effects (1a) through (1c) described in the first embodiment and the following effect in addition.

(2a) According to the present embodiment, the correspondence between the connections C1, C2 associated with the type of the second protocol P2 and the logical addresses AA, BB assigned to the external tool 4 can be arbitrarily set or changed.

### 3. OTHER EMBODIMENTS

While some embodiments of the present disclosure have been described, the present disclosure is not limited to the embodiments described above and can be modified in various manners.

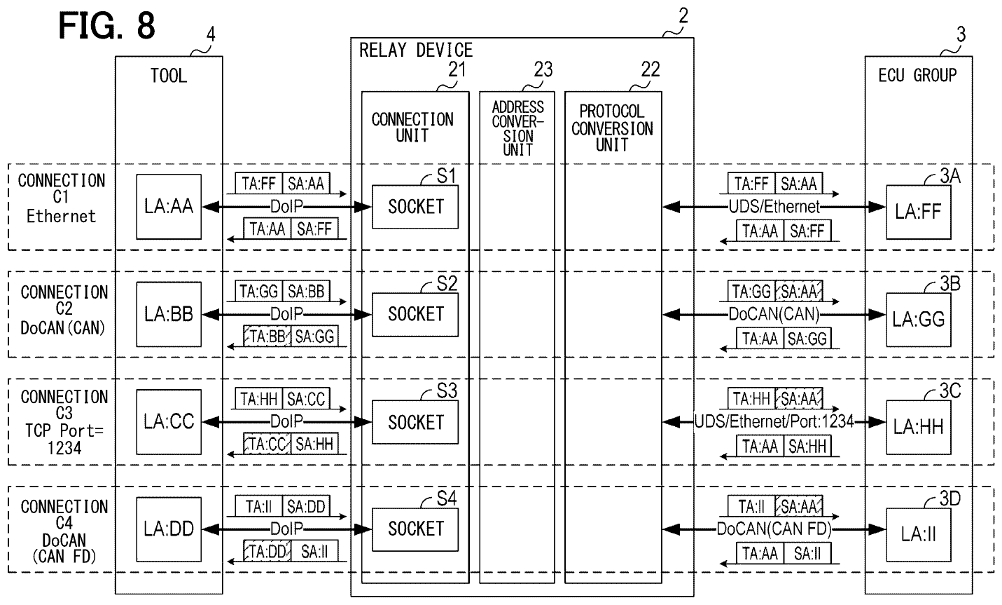

(3a) In the above embodiment, the case where two types of second protocols P21, P22 are mixed is described. However, three or more types of second protocols P2 may be mixed. For example, as shown in FIG. 8, when four second protocols P21 to P24 are mixed, four logical addresses AA, BB, CC, and DD are assigned to the external tool 4, and four sockets S1 to S4 are provided in the connection unit 21 of the relay device 2. The connections C1 to C4 established by the sockets S1 to S4 are associated with second protocols P21 to P24, respectively. In other words, even when the communication speeds are different between Ethernets or between CANs, the connections may be selectively used. Here, the configuration is such that all four types of second protocols P21 to P24 are supported, but the configuration may be such that any two or three of these are supported. Also, it may be configured to support protocols other than the second protocols P21 to P24.

(3b) In the above embodiment, one of the logical addresses LA (i.e., tool address) assigned to the external tool 4 is used as the ECU address, but a logical address LA different from the tool address may be used as the ECU address. In addition, the ECU address does not need to be the same for all types of the second protocol P2, and may be different for each type of the second protocol P2.

(3c) In the above embodiment, the information on the internal connection terminals T1 and T2 from which the diagnostic message has been received is used as the speed-related information. Alternatively, the speed-related information may be an SA included in the diagnostic message. In this case, the ECU that is the transmission source can be identified from the SA, and further, the type of the second protocol P2 used by that ECU can be identified. Furthermore, for example, when the second protocol P2 includes Ethernet protocols with different speeds, the speed-related information may be information on lower protocols such as TCP/UDP port numbers, IP addresses, and MAC addresses. Further, for example, when the second protocol P2 includes a mixture of CAN, CAN FD, CAN XL, and the like, which have different speeds, CAN channel identification information (e.g., FDF bit) or CAN ID, which is added to the CAN frame, may be used as the speed-related information. The FDF is an abbreviation for FD Format indicator.

(3d) The relay device 2 and the method according to the present disclosure may be achieved by a dedicated computer provided by constituting a processor and a memory programmed to execute one or more functions embodied by a computer program. Alternatively, the relay device 2 and the method according to the present disclosure may be achieved by a dedicated computer provided by constituting a processor with one or more dedicated hardware logic circuits. Alternatively, the relay device 2 and the method according to the present disclosure may be achieved using one or more dedicated computers constituted by a combination of the processor and the memory programmed to execute one or more functions and the processor with one or more hardware logic circuits. Furthermore, the computer program may be stored in a computer-readable non-transitory tangible storage medium as an instruction executed by the computer. The method for implementing the functions of the respective units included in the relay device 2 does not necessarily need to include software, and all of the functions may be implemented with the use of one or multiple hardware.

(3e) The multiple functions of one component in the above embodiments may be implemented by multiple components, or a function of one component may be implemented by multiple components. Further, multiple functions of multiple components may be implemented by one component, or one function implemented by multiple components may be implemented by one component. Part of the configuration of the above embodiment may be omitted. At least a part of the configuration in one embodiment may be added to or substituted for the configuration of another embodiment.

(3f) In addition to the relay device described above, various features such as a system having the relay device as a component, a program for making a computer function as the relay device, a non-transitory tangible storage medium such as a semiconductor memory in which the program is stored, and a method of relay may be provided to implement the present disclosure.

What is claimed is:

1. A relay device configured to relay data between a plurality of electronic devices, the relay device comprising:
a protocol conversion unit configured to perform mutual conversion between a first protocol used for communication with a first electronic device and a second protocol used for communication with a second electronic device; and
an address conversion unit configured to, according to a conversion table that mutually associates an external address and an internal address that are address information used for indicating the first electronic device in a higher protocol,
convert the external address indicated in a message from the first electronic device to the second electronic device into the internal address, and
convert the internal address indicated in a message from the second electronic device to the first electronic device into the external address,
wherein
the external address is a plurality of external addresses,
the plurality of external addresses are assigned to one first electronic device,
the conversion table is set to associate a different external address with each type of the second protocol identified by speed-related information, and
the speed-related information is information used when identifying a type of the second protocol based on a difference in a communication speed.

2. The relay device according to claim 1, further comprising
a connection unit configured to set a plurality of lower connections,
wherein
the plurality of lower connections are a lower protocol connection used in a lower layer than the higher protocol in the first protocol, and are used for connection with one first electronic device,
each lower connection is associated with a different external address, and
the plurality of lower connections set by the connection unit are used according to the speed-related information.

3. The relay device according to claim 1, wherein
either information for identifying a physical path to which the second electronic device is connected or information on a lower protocol used in a lower layer than the higher protocol in the second protocol is used as the speed-related information.

4. The relay device according to claim 3, wherein
information on the lower protocol includes any one of a transmission control protocol (TCP)/user datagram protocol (UDP) port number, an internet protocol (IP) address, a media access control (MAC) address, a control area network protocol (CAN, registered trademark) ID, and CAN channel identification information.

5. The relay device according to claim 1, wherein
in the conversion table, all the internal addresses associated with the same first electronic device have a same value.

6. The relay device according to claim 1, wherein
the address conversion unit is configured to update a content of the conversion table according to the external address indicating a transmission source indicated in a message of the higher protocol, the message being received from the first electronic device, and information specifying a type of the second protocol used at a transmission destination.

7. The relay device according to claim 1, wherein
the higher protocol in the first protocol includes diagnostic over IP (DoIP), and
a lower protocol used in a lower layer than the higher protocol in the first protocol includes a transmission control protocol (TCP).

8. The relay device according to claim 1, wherein
the second protocol includes any one of diagnostic communication over controller area network (DoCAN), unified diagnostic services (UDS), and Ethernet (registered trademark).

9. A data relay method for relaying data between a plurality of electronic devices, the method comprising:
performing mutual conversion between a first protocol used for communication with a first electronic device and a second protocol used for communication with a second electronic device; and
according to a conversion table that mutually associates an external address and an internal address that are address information used for indicating the first electronic device in a higher protocol,
converting an external address indicated in a message from the first electronic device to the second electronic device into the internal address;
converting the internal address indicated in a message from the second electronic device to the first electronic device into the external address, wherein the external address is a plurality of external addresses;
assigning the plurality of external addresses to one first electronic device; and
setting the conversion table to associate a different external address with each type of the second protocol identified by speed-related information,
wherein
the speed-related information is information used when identifying a type of the second protocol based on a difference in a communication speed.

10. A non-transitory computer-readable storage medium storing a program for causing a computer to:
relay data between a plurality of electronic devices;
perform mutual conversion between a first protocol used for communication with a first electronic device and a second protocol used for communication with a second electronic device; and
according to a conversion table that mutually associates an external address and an internal address that are address information used for indicating the first electronic device in a higher protocol,
convert an external address indicated in a message from the first electronic device to the second electronic device into the internal address, and
convert the internal address indicated in a message from the second electronic device to the first electronic device into the external address,
wherein
the external address is a plurality of external addresses,
the plurality of external addresses are assigned to one first electronic device,
the conversion table is set to associate a different external address with each type of the second protocol identified by speed-related information, and
the speed-related information is information used when identifying a type of the second protocol based on a difference in a communication speed.
